(19) United States
(12) Patent Application Publication
(10) Pub. No.: US 2025/0283684 A1
(43) Pub. Date: Sep. 11, 2025

(54) ADVANCED LIGHTWEIGHT BARREL DESIGN

(71) Applicant: Joshua R. Eubank, Woodford, VA (US)

(72) Inventor: Joshua R. Eubank, Woodford, VA (US)

(73) Assignee: United States of America, as represented by the Secretary of the Navy, Arlington, VA (US)

(21) Appl. No.: 18/595,626

(22) Filed: Mar. 5, 2024

(51) Int. Cl. F41A 21/02; B33Y 80/00; F41A 21/18

(52) U.S. Cl. CPC F41A 21/02; F41A 21/18; B33Y 80/00

(57) ABSTRACT

A gun barrel that includes an inner barrel, an outer barrel, and a lattice structure. The lattice structure decreases the weight of the barrel while increasing the stiffness of the inner barrel by connecting the inner barrel to the outer barrel.

### STATEMENT OF GOVERNMENT INTEREST

The invention described was made in the performance of official duties by one or more employees of the Department of the Navy, and thus, the invention herein may be manufactured, used or licensed by or for the Government of the United States of America for governmental purposes without the payment of any royalties thereon or therefor.

### BACKGROUND

The disclosure relates generally to firearms engineering, and more specifically, to an improved barrel design utilizing 3D printed lattice structures to enhance weight efficiency, stiffness, and heat dissipation properties.

Traditional methods for reducing the weight of firearm barrels typically involve the incorporation of spiral or longitudinal channels, achieved through conventional manufacturing techniques. These methods are primarily limited to modifications of the barrel's exterior geometry. Interior modifications, while possible, rely on layered geometries that do not fully exploit the potential of non-machinable structures, such as lattices and gyroids, due to the limitations of traditional manufacturing processes.

### SUMMARY

This disclosure introduces a novel barrel design utilizing advanced 3D printing technologies to incorporate a lattice structure within the barrel, achieving considerable weight reduction and improved thermal properties without sacrificing stiffness or accuracy. This lattice structure is encapsulated within a thin exterior structure that connects the outer legs of the lattice, further contributing to the barrel's structural integrity. The design is not material-dependent, offering flexibility in choosing materials based on specific application requirements.

### BRIEF DESCRIPTION OF THE DRAWINGS

These and various other features and aspects of various exemplary embodiments will be readily understood with reference to the following detailed description taken in conjunction with the accompanying drawings, in which like or similar numbers are used throughout, and in which:

FIG. 1 is a cross-section of the lightweight barrel;

FIG. 2A is an end view of the lightweight barrel;

FIG. 2B is a close up of a quarter of the barrel; and

FIG. 3 is a close up of a cross-section of the lightweight barrel.

### DETAILED DESCRIPTION

The disclosed methods and systems below may be described generally, as well as in terms of specific examples and/or specific embodiments. For instances where references are made to detailed examples and/or embodiments, it should be appreciated that any of the underlying principles described are not to be limited to a single embodiment but may be expanded for use with any of the other methods and systems described herein as will be understood by one of ordinary skill in the art unless otherwise stated specifically.

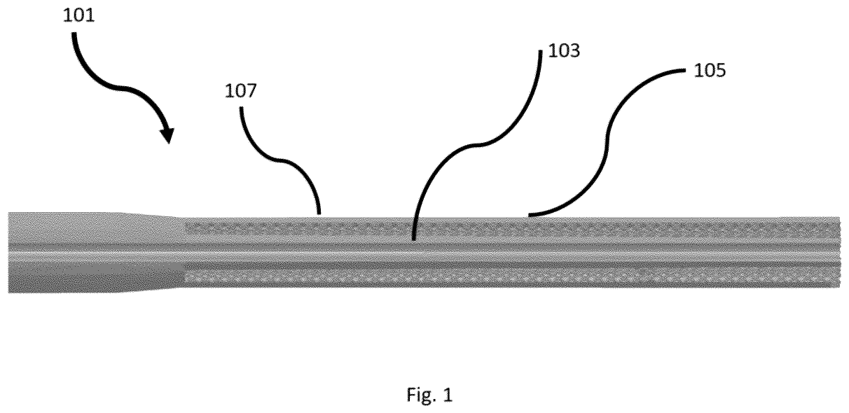

FIG. 1 shows a cross-section of the lightweight barrel 101. As shown, gun barrel 101 includes an inner barrel 103, a lattice structure 105, and an outer barrel 107.

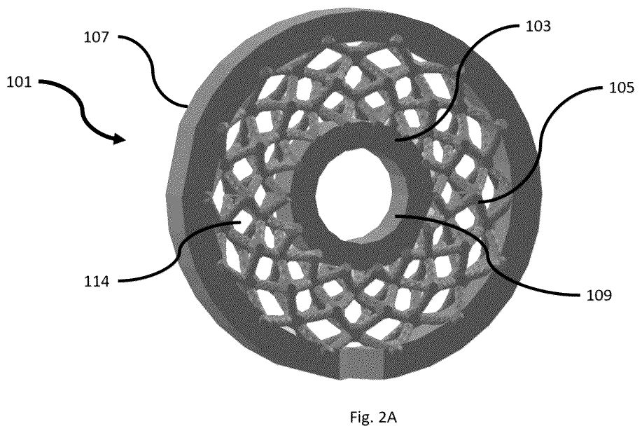

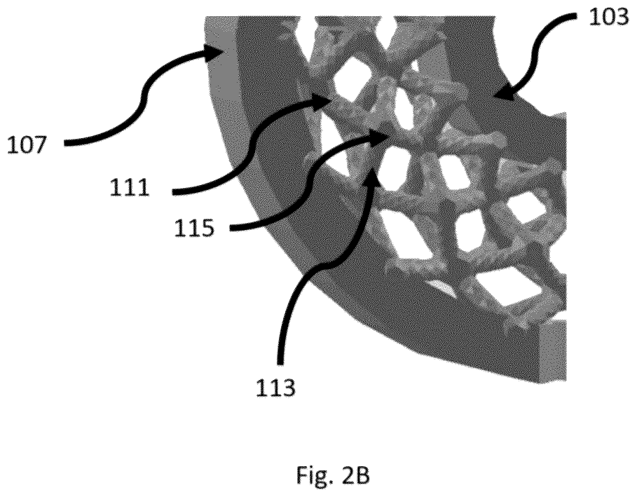

FIG. 2A-B shows an end view of the lightweight barrel 101. The barrel 101 includes an inner barrel 103, a lattice structure 105, and an outer barrel 107. The inner barrel 103 can withstand the pressures of the propellant gases. The inner barrel 103 includes rifling 109 integrated into the tubular structure to ensure a proper gas seal and spin stabilization of the projectile. The lattice structure 105 is a cross-shaped support structure within the tubular structure, optimized for weight reduction and increased stiffness. The thickness of a plurality of lattice legs 111, 113 is adjustable to balance weight savings with the required structural integrity. As shown also shown in FIG. 2B, a plurality of lattice legs 111 originate from the inner barrel 103 in a clockwise direction and terminate at the outer barrel 107 and a plurality of lattice legs originate from the inner barrel 103 in a counterclockwise direction and terminating at the outer barrel 107. Legs 111 and legs 113 form a plurality of nodes 115 where they intersect. The outer barrel 107 is a thin shell that encases the lattice structure 105, securing an outer end of the lattice legs 111, 113 and contributing to the overall rigidity and durability of the barrel. The gaps 114 allow for the cooling of the barrel and also allows for a reduction in weight while increasing the stiffness of the gun barrel 101.

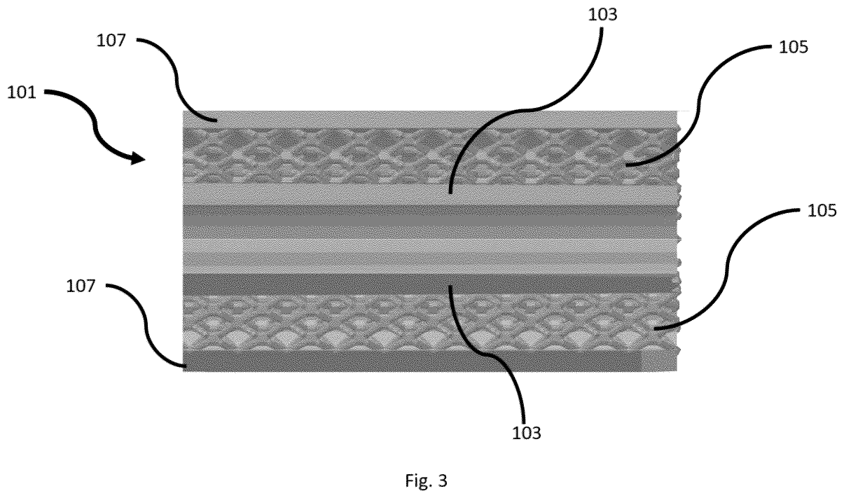

FIG. 3 shows a close up of a cross-section of the lightweight barrel 101. This view shows that the lattice 105 also propagates along the axis of the gun barrel 101 in addition to axially as shown in FIG. 2. The lattice 105 carries both axial and radial forces between the inner barrel 103 and the outer barrel.

Advanced 3D printing techniques are leveraged to manufacture the disclosed barrel. 3D printing is also known as additive manufacturing. Different additive manufacturing techniques, such as Directed Energy Deposition and Electron-Beam Melting, are used to create complex internal geometries. This approach allows for 1) a significant weight reduction (up to 24% in initial iterations) without compromising barrel stiffness or accuracy of a baseline barrel; 2) improved heat dissipation properties due to the unique geometries of the lattice and potential porosity adjustments in the outer barrel; 3) enhanced customization capabilities in adjusting the lattice structure for specific application needs.

The invention contemplates various modifications to the exterior structure, including increasing its porosity to further enhance thermal dissipation and reduce weight. These variations can be implemented through the same 3D printing technologies used to create the primary lattice structure.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments.

What is claimed is:

1. A gun barrel, the barrel comprising:
an inner barrel;
an outer barrel; and
a lattice structure which decreases the weight of the barrel while increasing the stiffness of the inner barrel by connecting the inner barrel to the outer barrel.

2. The gun barrel according to claim 1, wherein the lattice structure further comprising:
a plurality of first legs originating from the inner barrel in a clockwise direction and terminating at the outer barrel; and
a plurality of second legs originating from the inner barrel in a counterclockwise direction and terminating at the outer barrel.

3. The gun barrel according to claim 2, wherein the lattice structure further comprising:
a plurality of nodes formed at the intersection of the first and second legs.

4. The gun barrel according to claim 2, wherein the inner barrel further comprises rifling to provide for proper gas seal and bullet spin.

5. The gun barrel according to claim 1, wherein the gun barrel is manufactured using additive manufacturing.

6. The gun barrel according to claim 5, wherein the lattice structure maintains the barrel stiffness of a baseline barrel while achieving a weight reduction of up to 24% over the baseline barrel.

7. The gun barrel according to claim 5, wherein the gun barrel further comprises a lattice geometry and outer barrel porosity that results in increased heat dissipation over a baseline barrel.

8. The gun barrel according to claim 1, wherein the gun barrel is manufactured by directed energy deposition.

9. The gun barrel according to claim 1, wherein the gun barrel is manufactured by electron-beam melting.

10. A method for manufacturing a gun barrel, the method comprising:
designing an inner barrel;
integrating a lattice structure fixed on an exterior surface of the inner barrel;
encapsulating the lattice structure between the inner barrel and an outer barrel; and
incorporating rifling on an internal surface of the inner barrel.

11. The method of claim 10, wherein the lattice structure further comprises a plurality of legs to optimize the weight reduction and stiffness of the gun barrel over a baseline barrel.

12. The method of claim 10, wherein the outer barrel's porosity is adjusted to optimize heat dissipation properties.

13. The method of claim 10, further comprising the customizing the thickness of a lattice structure's plurality of legs based on desired weight savings and stiffness requirements.

14. The method of claim 10, wherein the gun barrel is manufactured by additive manufacturing.

15. The method of claim 10, wherein the lattice structure maintains the barrel stiffness of a baseline barrel while achieving a weight reduction of up to 24% over the baseline barrel.

16. The method of claim 10, wherein the gun barrel further comprises a lattice geometry and outer barrel porosity that results in increased heat dissipation over a baseline barrel.

17. The method of claim 10, wherein the gun barrel is manufactured by directed energy deposition.

18. The method of claim 10, wherein the gun barrel is manufactured by electron-beam melting.
